(19) United States
(12) Patent Application Publication
(10) Pub. No.: US 2012/0114901 A1
(43) Pub. Date: May 10, 2012

(54) COVER GLASS FOR FLAT PANEL DISPLAYS AND METHOD FOR PRODUCING THE SAME

(75) Inventors: Keiichiro URAJI, Tokyo (JP); Satoshi KANASUGI, Tokyo (JP); Sanae FUJITA, Tokyo (JP); Hiroshi WAKATSUKI, Tokyo (JP)

(73) Assignee: Asahi Glass Company, Limited, Chiyoda-ku (JP)

(21) Appl. No.: 13/288,564

(22) Filed: Nov. 3, 2011

(30) Foreign Application Priority Data
Nov. 10, 2010 (JP) 2010-251584

(51) Int. Cl. B32B 3/04; C03C 21/00; C03B 23/025

(52) U.S. Cl. 428/121; 65/30.1

(57) ABSTRACT

The present invention provides a cover glass for flat panel displays, which can simplify an edge treatment and is excellent in design, and a method for producing the same. The method includes: a local heating step S3 of locally heating regions 1b to be the bent portions 33 of the cover glass 30 in the sheet glass 1; and a bending step S4 of forming the skirt portions 32 by bending the sheet glass 1 at the regions 1b to be the bent portions 33, during or after the local heating step.

### FIELD OF THE INVENTION

The present invention relates to a cover glass for flat panel displays, which covers the whole surface of an image display portion, and a method for producing the same.

### BACKGROUND OF THE INVENTION

In recent years, in flat panel displays, it has been performed to arrange a thin sheet cover glass for flat panel displays in front of a display so as to cover a wider region than an image display portion (for example, Patent Document 1).

Further, there has been employed a structure of arranging the thin sheet cover glass for flat panel displays so as to cover the whole surface of the flat panel display, thereby concealing a convex portion of a frame to improve the appearance.

### Patent Document 1: JP-A-2010-169788

### SUMMARY OF THE INVENTION

However, when the cover glass for flat panel displays is arranged so as to cover the whole surface of the flat panel display, edges thereof are exposed on a front side of the flat panel display. Accordingly, it has been necessary to precisely perform a chamfering treatment or the like of the edges. Further, when something comes into contact with the edges, there has been a possibility that the edges are chipped.

Furthermore, a cover glass for flat panel displays, which is excellent in design, has been demanded from industry, utilizing a texture of glass, and there has been room for improvement.

The invention has been made in view of the above-mentioned circumstances, and an object thereof is to provide a cover glass for flat panel displays, which can simplify an edge treatment and is excellent in design, and a method for producing the same.

Namely, the present invention relates to the following (1) to (11).

(1) A cover glass for flat panel displays, which is formed of a sheet glass, the cover glass comprising:

a display portion planarly extending and being positioned in front of an image display portion; and

bent portions bent from the display portion on both sides in a width direction of the display portion.

(2) The cover glass for flat panel displays according to (1),

wherein, in a cross section in a thickness direction of the cover glass, a first space portion is formed forward between a first virtual line extending a back surface of the sheet glass forming the display portion in the width direction and a back surface of the sheet glass forming the bent portion, and

a maximum distance in a front-back direction of the first space portion is 0.14 mm or less.

(3) The cover glass for flat panel displays according to item (1) or (2), wherein the cover glass has skirt portions extending backward from the bent portions.

(4) The cover glass for flat panel displays according to (3), wherein the skirt portions are formed by bending the sheet glass at the bent portions.

(5) The cover glass for flat panel displays according to (4),

wherein a second space portion is formed laterally between a second virtual line perpendicular to the first virtual line and passing through an inner backside edge of the skirt portion and the back surface of the sheet glass forming at least one of the bent portion and the skirt portion, and

a maximum distance in a width direction of the second space portion is 0.5 mm or less.

(6) A method for producing a cover glass for flat panel displays, which is formed of a sheet glass and comprises a display portion planarly extending and being positioned in front of an image display portion, bent portions bent from the display portion on both sides in a width direction of the display portion and skirt portions extending backward from the bent portions, the method comprising:

a chemical strengthening step; and

a sheet glass processing step of preparing a sheet glass to be subjected to the chemical strengthening step,

wherein the sheet glass processing step comprises:

a heating step of heating regions to be the display portion and the skirt portions in the sheet glass or the whole sheet glass to have a predetermined viscosity;

a local heating step of locally heating regions to be the bent portions in the sheet glass; and

a bending step of forming the skirt portions by bending the sheet glass at the regions to be the bent portions, during or after the local heating step.

(7) The method for producing a cover glass for flat panel displays according to (6),

wherein, in the heating step, heating is performed so that the viscosity of the regions to be the display portion and the skirt portions in the sheet glass or the whole sheet glass becomes 10¹¹ to 10¹⁵ Pa·s, and

in the local heating step, local heating is performed so that a maximum viscosity of the regions to be the bent portions becomes 10⁷ to 10⁹ Pa·s and so that a distance in a width direction between a maximum viscosity point showing the maximum viscosity of the regions to be the bent portions and a low viscosity adjacent point closest to the maximum viscosity point in a width direction, in regions in which the viscosity becomes 10¹¹ to 10¹⁵ Pa·s, becomes 30 mm or less.

(8) The method for producing a cover glass for flat panel displays according to (6) or (7), wherein, in at least the local heating step and the bending step, the sheet glass is bent at the regions to be the bent portions under its own weight by:

using a die having at least vertical surfaces extending in a direction of gravitational force, a horizontal surface extending in a direction perpendicular to the direction of gravitational force and arc surfaces having a predetermined curvature connecting the horizontal surface and each of the vertical surfaces;

arranging the region to be the display portion on the horizontal surface, arranging the regions to be the bent portions so as to face the arc surfaces, and arranging the regions to be the skirt portions so as to protrude from the vertical surfaces; and

locally heating the sheet glass.

(9) The method for producing a cover glass for flat panel displays according to (6) or (7), wherein, in the local heating step and the bending step, the sheet glass is bent at the regions to be the bent portions under its own weight by:

using a die having at least vertical surfaces extending in a direction of gravitational force, a horizontal surface extending in a direction perpendicular to the direction of gravitational force and arc surfaces having a predetermined curvature connecting the horizontal surface and each of the vertical surfaces;

arranging the region to be the display portion on the horizontal surface, arranging the regions to be the bent portions so as to face the arc surfaces, and arranging the regions to be the skirt portions so as to protrude from the vertical surfaces; and

locally heating the sheet glass, and pressing the regions to be the skirt portions to the vertical surfaces.

(10) The method for producing a cover glass for flat panel displays according to any one of (6) to (9), wherein, in the local heating step, the regions to be the bent portions are heated with a heating member in a noncontact state in the furnace.

(11) A method for producing a cover glass for flat panel displays, which is formed of a sheet glass and comprises a display portion planarly extending and being positioned in front of an image display portion and bent portions bent from the display portion on both sides in a width direction of the display portion, the method comprising:

a chemical strengthening step; and

a sheet glass processing step of preparing a sheet glass to be subjected to the chemical strengthening step,

wherein the sheet glass processing step comprises:

a heating step of heating region to be the display portion and regions to be skirt portions positioned on the opposite side of the display portion with respect to the bent portions in the sheet glass or the whole sheet glass to have a predetermined viscosity;

a local heating step of locally heating regions to be the bent portions in the sheet glass;

a bending step of forming the skirt portions by bending the sheet glass at the regions to be the bent portions, during or after the local heating step; and

a skirt portion removing step of cutting the cover glass at the bent portions or between the bent portions and the skirt portions to remove the skirt portions.

According to the cover glass for flat panel displays described in (1) of the invention, the bent portions are formed on both sides in the width direction of the display portion, thereby being able to impart a higher-class feeling to the cover glass for flat panel displays, utilizing a texture of glass, to improve the design. Further, edges of the cover glass for flat panel displays are provided in the bent portions or skirt portions and face backward, so that a chamfering treatment can be simplified, compared to the case where the edges are exposed forward. Furthermore, there can be reduced a possibility that chipping of the edges occurs.

Further, according to the cover glass for flat panel displays described in (2) of the invention, the design of the cover glass for flat panel displays can be prevented from being deteriorated.

Still further, according to the cover glass for flat panel displays described in (3) of the invention, the design is more improved.

Furthermore, according to the cover glass for flat panel displays described in (4) of the invention, the cover glass for flat panel displays, which is excellent in design, can be easily produced from the glass sheet.

In addition, according to the cover glass for flat panel displays described in (5) of the invention, the design of the cover glass for flat panel displays can be prevented from being deteriorated.

According to the method for producing a cover glass for flat panel displays described in (6) of the invention, there can be produced the cover glass for flat panel displays, which is good in design and has a higher-class feeling utilizing a texture of glass. Further, edges of the cover glass for flat panel displays are provided in the skirt portions and face backward, so that the chamfering treatment can be simplified, compared to the case where the edges are exposed forward. Furthermore, there can be reduced a possibility that chipping of the edges occurs.

Further, according to the method for producing a cover glass for flat panel displays described in (7) of the invention, there can be produced the cover glass for flat panel displays, which is excellent in design, while inhibiting an influence of the display portion on visibility and inhibiting cracks of the glass.

Furthermore, according to the methods for producing a cover glass for flat panel displays described in (8) and (9) of the invention, productivity can be improved.

In addition, according to the method for producing a cover glass for flat panel displays described in (10) of the invention, local heating can be performed to a desired viscosity.

According to the method for producing a cover glass for flat panel displays described in (11) of the invention, there can be produced the cover glass for flat panel displays, which is good in design and has a higher-class feeling utilizing a texture of glass. Further, edges of the cover glass for flat panel displays are provided in the skirt portions and face backward, so that the chamfering treatment can be simplified, compared to the case where the edges are exposed forward. Furthermore, there can be reduced a possibility that chipping of the edges occurs.

### BRIEF DESCRIPTION OF THE DRAWINGS

FIG. 1 is a cross-sectional view of a flat panel display device in which a cover glass for flat panel displays of one embodiment of the invention is arranged.

FIG. 2 is a partially enlarged view of the cover glass for flat panel displays of FIG. 1.

FIG. 3 is a flow chart of a method for producing a cover glass for flat panel displays.

FIG. 4 is a schematic view of an apparatus for producing a cover glass for flat panel displays.

FIG. 5 is a schematic diagram for illustrating local heating.

FIG. 6 shows heating conditions of (a) uniform heating, (b) heating of the whole skirt and (c) local heating and graphs showing simulation results obtained thereby.

FIG. 7 is a view showing a cross-sectional shape of a cover glass for flat panel displays obtained by the uniform heating of (a) in FIG. 6.

FIG. 8 is a photograph of a cover glass for flat panel displays produced by the uniform heating of (a) in FIG. 6, which is irradiated with a fluorescent light.

FIG. 9 shows heating conditions different from the local heating of (c) in FIG. 6 and graphs showing simulation results obtained thereby.

FIG. 10 is a cross-sectional view of a flat panel display device in which a cover glass for flat panel displays of a modified embodiment of the invention.

### DETAILED DESCRIPTION OF THE INVENTION

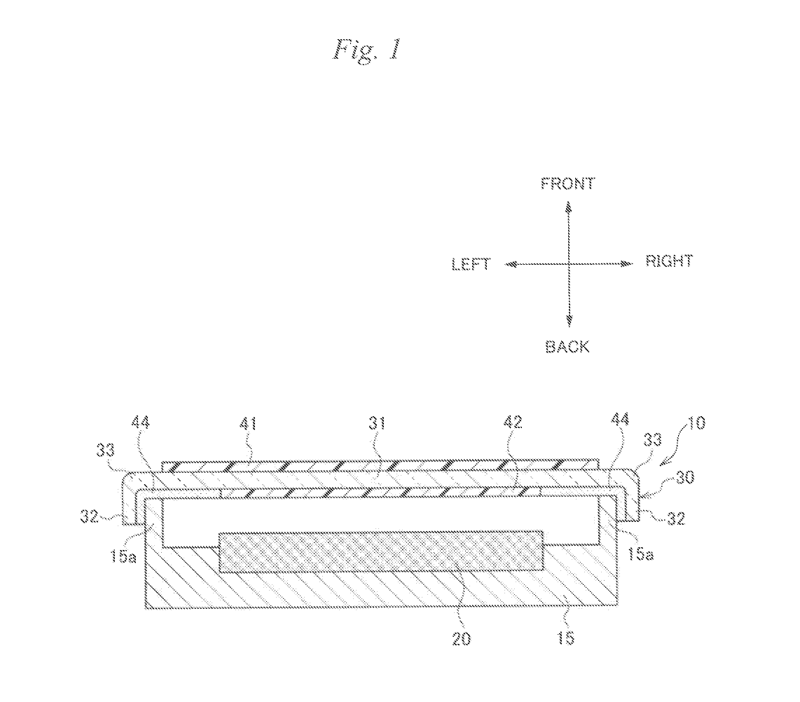

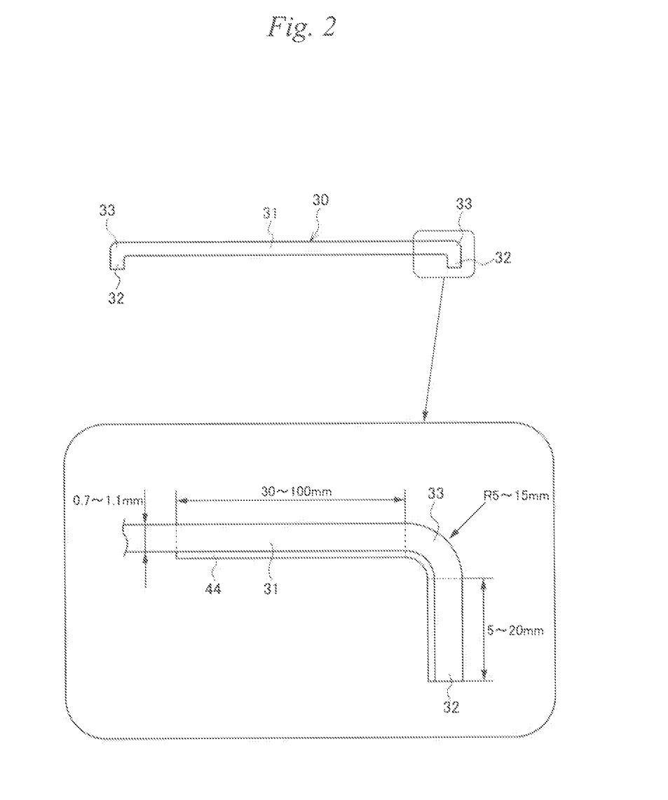

The cover glass for flat panel displays of the invention and the method for producing the same will be described below. FIG. 1 is a cross-sectional view of a flat panel display device in which a cover glass for flat panel displays of one embodiment of the invention is arranged, and FIG. 2 is a partially enlarged view of the cover glass for flat panel displays of FIG. 1.

First, one embodiment of the flat panel display device (hereinafter occasionally simply referred to as the display device) using the cover glass for flat panel displays (hereinafter occasionally simply referred to as the cover glass) will be described with reference to FIG. 1.

The display device 10 is provided with a display panel 20 generally mounted in a housing 15 and a cover glass 30 provided so as to cover the whole surface of the display panel 20 and to surround the front of the housing 15, as shown in FIG. 1.

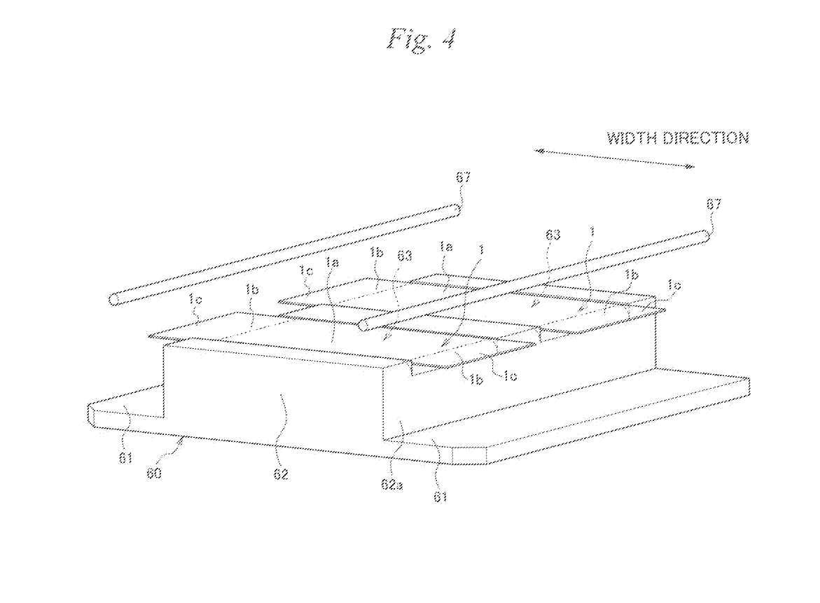

The cover glass 30 is provided mainly for the purposes of improving appearance and strength of the display 10, preventing impact failure, and the like, and formed of one straight sheet glass or laminated sheet glass (hereinafter generically referred to as a sheet glass 1 (see FIG. 4)). The term “straight” means that the whole shape as the appearance is approximately planar, and the sheet glass is one usually called as a glass sheet. The cover glass 30 includes a display portion 31 planarly extending and being positioned in front of the display panel 20, bent portions 33 bent from the display portion 31 on both sides in a horizontal direction (width direction) of the display portion 31 and skirt portions 32 extending backward from the bent portions 33. Incidentally, the cover glass 30 may be provided so as to be apart from a display side (front side) of the display panel 20, as shown in FIG. 1, or may be attached to the display side of the display panel 20 through an adhesive film (not shown) having transparency.

The skirt portions 32 are formed by bending the sheet glass 1 at the bent portions 33 as described later, and provided so as to put side walls 15a of the housing 15 between the both skirt portions 32.

A functional film 41 is provided on a front surface of the display portion 31 from which light from the display panel 20 is emitted, and a functional film 42 is provided on a back surface which the light from the display panel 20 enters, in a position corresponding to the display panel 20. Incidentally, the functional films 41 and 42 are provided on the both sides in FIG. 1. However, without being limited thereto, the functional film may be provided on only the front surface or the back surface, or may be omitted.

The functional films 41 and 42 have functions such as antireflection of surrounding light, impact failure prevention, electromagnetic wave shielding, near-infrared shielding, color compensation and/or improvement of resistance to flaws, and the thickness, the shape and the like thereof are appropriately selected depending on use. The functional films 41 and 42 are formed, for example, by attaching resin-made films to the cover glass 30, or may be formed by a thin-film forming method such as a vapor deposition method, a sputtering method or a CVD method.

Further, black layers 44 are provided approximately in frame form in the whole periphery, on a region outside the display panel 20, of the back surface of the display portion 31, and on back surfaces of the bent portions 33 and the skirt portions 32. The black layers 44 are films formed, for example, by applying an ink containing pigment particles to the cover glass 30, and subjecting this to ultraviolet irradiation or heat burning, followed by cooling. The display panel 20 and the like become invisible from the outside of the housing 15 to improve sensuousness of appearance.

In the cover glass 30, the length of the region outside the display panel 20 of the display portion 31 is preferably, for example, from 30 to 100 mm, the length of the skirt portions 32 is preferably, for example, from 5 to 20 mm, the curvature radius of the bent portions 33 is preferably, for example, from 5 to 15 mm, and the thickness of the sheet glass 1 is preferably, for example, from 0.7 to 1.1 mm, as shown in FIG. 2.

As this cover glass 30 for flat panel displays, there is used each of glasses having the following compositions:

(i) A glass containing, in terms of mol%, 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂;

(ii) A glass containing, in terms of mol%, 50 to 74% of SiO₂, 1 to 10% of Al₂O₃, 6 to 14% of Na₂O, 3 to 11% of K₂O, 2 to 15% of MgO, 0 to 6% of CaO and 0 to 5% of ZrO₂, wherein the total of the contents of SiO₂ and Al₂O₃ is 75% or less, the total of the contents of Na₂O and K₂O is from 12 to 25%, and the total of the contents of MgO and CaO is from 7 to 15%;

(iii) A glass containing, in terms of mol%, 68 to 80% of SiO₂, 4 to 10% of Al₂O₃, 5 to 15% of Na₂O, 0 to 1% of K₂O, 4 to 15% of MgO and 0 to 1% of ZrO₂; and

(iv) A glass containing, in terms of mol%, 67 to 75% of SiO₂, 0 to 4% of Al₂O₃, 7 to 15% of Na₂O, 1 to 9% of K₂O, 6 to 14% of MgO and 0 to 1.5% of ZrO₂, wherein the total of the contents of SiO₂ and Al₂O₃ is from 71 to 75%, the total of the contents of Na₂O and K₂O is from 12 to 20%, and when CaO is contained, the content thereof is less than 1%.

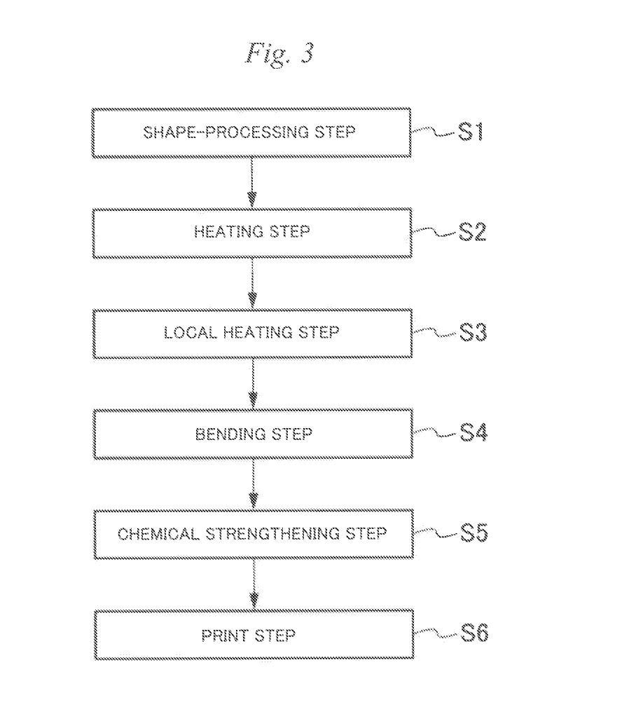

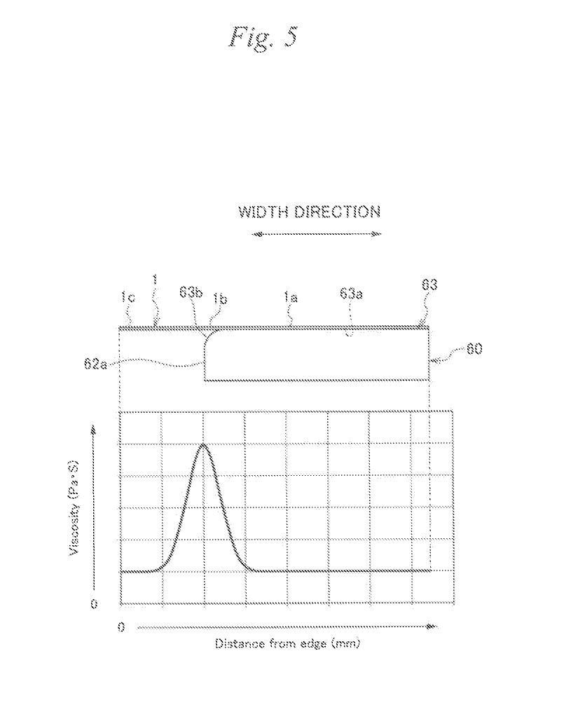

The method for producing the cover glass 30 for flat panel displays will be described below. FIG. 3 is a flow chart of the method for producing the cover glass for flat panel displays, FIG. 4 is a schematic view of an apparatus for producing the cover glass for flat panel displays, and FIG. 5 is a schematic diagram for illustrating local heating.

The method for producing the cover glass 30 includes a shape-processing step (S1), a heating step (S2), a local heating step (S3), a bending step (S4), a chemical strengthening step (S5) and a print step (S6) in general as shown in FIG. 3.

The shape-processing step (S1) is a treatment for cutting out the sheet glass 1 to a predetermined shape, typically to a rectangular shape, and the heating step (S2) is a treatment for heating the sheet glass 1 to a predetermined viscosity. The local heating step (S3) is a treatment for locally heating the sheet glass 1, and the bending step (S4) is a treatment for bending the sheet glass 1 to a predetermined shape. The chemical strengthening step (S5) is a treatment for chemically strengthening the sheet glass 1, and the print step (S6) is a treatment for forming the black layers 44. Incidentally, known methods are employed in the shape-processing step (S1), the chemical strengthening step (S5) and the print step (S6), and the shape-processing step (S1), the heating step (S2), the local heating step (S3) and the bending step (S4) constitute a sheet glass-processing step.

The heating step (S2), the local heating step (S3) and the bending step (S4) characterized in the invention will be described in detail below.

The heating step (S2), the local heating step (S3) and the bending step (S4) are performed in an electric furnace shown in FIG. 4. In the electric furnace, there are provided a die 60 on which the sheet glass 1 can be placed and movable electric heaters 67 which are disposed above both ends of the die 60.

The die 60 includes a sheet glass-placing table 62 which has a rectangular parallelepiped-like shape and has flanges 61 formed at lower ends thereof, and two concave sheet glass-arranging portions 63 provided on an upper surface thereof, on which two straight sheet glasses 1 can be arranged in parallel, as shown in FIGS. 4 and 5. Each sheet glass-arranging portion 63 has a horizontal surface 63a extending in a direction perpendicular to a direction of gravitational force and arc surfaces 63b having a predetermined curvature connecting the horizontal surface 63a and each of vertical surfaces 62a of the sheet glass-placing table 62. The length in a width direction of the horizontal surface 63a is shorter than the length in a width direction of the sheet glass 1. In sheet glass 1, a region 1a to be the display portion 31 is arranged on the horizontal surface 63a, regions 1b to be the bent portions 33 are arranged so as to face the arc surfaces 63b, and regions 1c to be the skirt portions 32 are arranged so as to protrude from the vertical surfaces 62a of the die 60. Incidentally, the shape of the die 60 should not be limited thereto, and it is only necessary to have the vertical surfaces 62a extending in the direction of gravitational force, the horizontal surface 63a extending in the direction perpendicular to the direction of gravitational force and the arc surfaces 63b connecting these both surfaces. The sheet glass-arranging portion 63 only requires that one sheet glass 1 can be placed thereon, and three or more sheet glasses 1 may be placed thereon.

Then, in the heating step (S2), the whole sheet glass 1 is preferably heated in the electric furnace to a predetermined viscosity, for example, 10¹¹ to 10¹⁵ Pa·s. In the local heating step (S3), it is preferable that the electric heaters 67 are moved to just above the regions lb to be the bent portions 33 to perform heating in a noncontact state to a predetermined temperature, thereby locally heating the regions 1b. At this time, local heating is preferably performed so that the maximum viscosity of the regions 1b becomes 10⁷ to 10⁹ Pa·s and so that the distance in the width direction between a maximum viscosity point showing the maximum viscosity of the regions 1b and a low viscosity adjacent point closest to the maximum viscosity point in the width direction, in regions in which the viscosity becomes 10¹¹ to 10¹⁵ Pa·s, becomes 30 mm or less. Incidentally, the heating step (S2) and the local heating step (S3) can also be performed at the same time. In this case, it is preferable that, in the heating step (S2), the regions 1a and 1c except for the regions 1b of the sheet glass 1 is heated to the predetermined viscosity, for example, 10¹¹ to 10¹⁵ Pa·s, and in the local heating step (S3), the local heating is performed so that the maximum viscosity of the regions 1b becomes 10⁷ to 10⁹ Pa·s and so that the distance in the width direction between the maximum viscosity point showing the maximum viscosity of the regions 1b and the low viscosity adjacent point becomes 30 mm or less.

Although borders between the region 1a and the regions 1b of the sheet glass 1 and borders between the regions 1b and the regions 1c are not necessarily clear herein, the region 1a, the regions 1b and the regions 1c certainly include the display portion 31, the bent portions 33 and the skirt portions 32, respectively. Further, the local heating of the regions 1b has an influence on the regions 1a and 1c in some cases. However, the local heating of the regions 1b to be the bent portions 33 means to heat around the regions 1b, and does not include to heat also the whole regions 1a and 1c.

In the heating step (S2), the whole sheet glass 1 is more preferably heated to a viscosity of 10¹³ to 10¹⁵ Pa·s, and in the local heating step (S3), the local heating is more preferably performed so that the maximum viscosity of the regions 1b becomes 10⁷ to 10⁸ Pa·s and so that the distance in the width direction between the maximum viscosity point showing the maximum viscosity of the regions 1b and the low viscosity adjacent point becomes 10 mm or less. Incidentally, although the viscosity of the glass and the temperature show different values depending on the composition of the sheet glass 1, it is preferred in production to select the glass having such a composition that the viscosity becomes 10⁷ to 10¹⁰ Pa·s at a temperature in the vicinity of 700 to 800° C.

When the sheet glass 1 reaches the predetermined viscosity or more by locally heating the regions 1b to be the bent portions 33 by using the electric heaters 67 as described above, the sheet glass 1 is bent at the regions 1b under its own weight, and the regions 1c positioned on the outside of the regions 1b form the skirt portions 32 approximately perpendicular to the display portion 31 along the vertical surfaces 62a of the die 60 (bending step (S4)).

Incidentally, in the above-mentioned embodiment, an example in which the sheet glass 1 is bent under its own weight has been described. However, instead of or together with its own weight, the sheet glass 1 may be bent by pressing the regions 1c or pinching ends of the regions 1c with pinches. Further, after the bending step (S4), ends of the skirt portions 32 (regions 1c) may be cut. Furthermore, although omitted in FIG. 3, the production method of the cover glass 30 includes a chamfering step, which is typically performed between the shape-processing step (S1) and the heating step (S2). However, when it is necessary to cut the ends of the skirt portions 32 after the bending step (S4), the chamfering step may be performed after the bending step (S4). In any case, the chamfering step can be performed more easily than ever before, because edges of the cover glass 30 are positioned behind the skirt portions 32.

Simulation results of the cover glasses produced changing heating conditions of the local heating will be described below. The following simulation has been performed on the assumptions that the glass has a composition containing, in terms of mol%, 71.95% of SiO₂, 1.34% of Al₂O₃, 0% of Li₂O, 8.82% of Na₂O, 5.37% of K₂O, 0.03% of MgO, 0.24% of CaO and 1.14% of ZrO₂ and that the sheet glass has a thickness of 0.7 mm. This sheet glass shows a viscosity of 1.13 Pa·s at 600° C., a viscosity of 0.765 Pa·s at 700° C. and a viscosity of 0.640 Pa·s at 800° C.

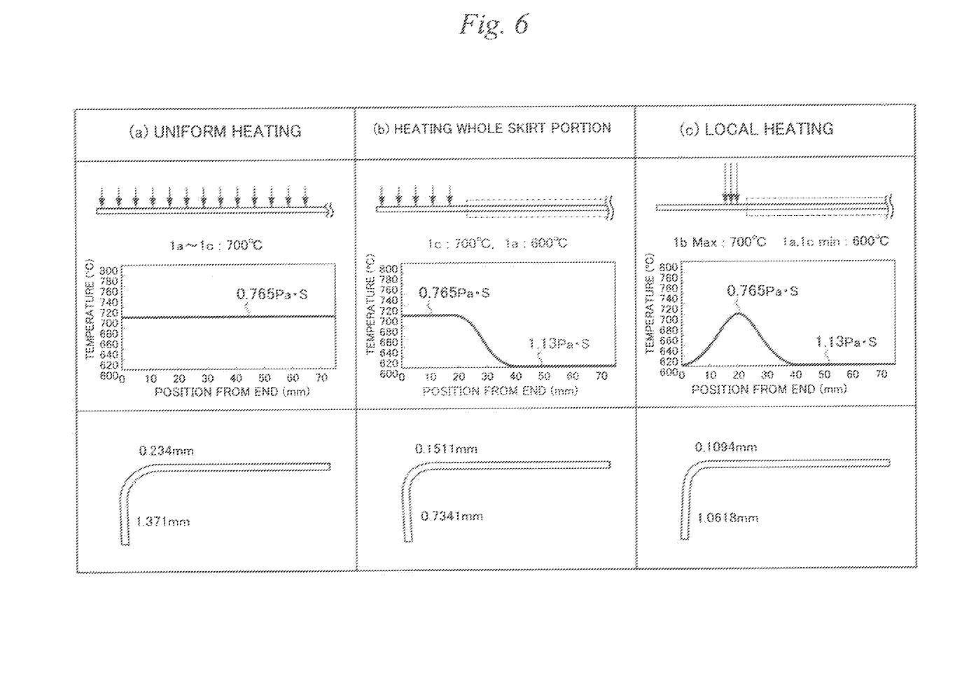

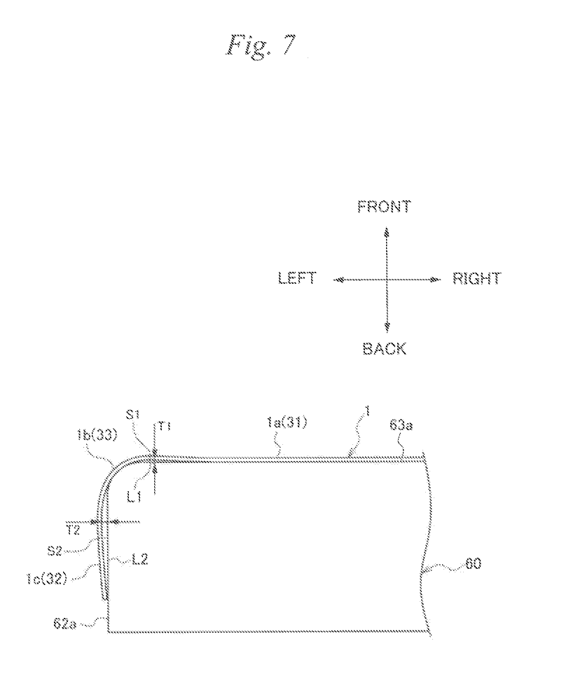

Item (a) in FIG. 6 shows, as a comparative example, simulation results at the time when the in-furnace temperature is set so that the whole sheet glass 1 is uniformly heated to 700° C. (viscosity: 0.765 Pa·s), thereby performing bending formation of the sheet glass 1. At this time, as shown in FIG. 7, in a cross section in a thickness direction, a first space portion S1 is formed forward between a first virtual line L1 (which coincides with the horizontal surface 63a of the die 60 in FIG. 7) extending the back surface of the sheet glass 1 forming the display portion 31 in the width direction and the back surface of the sheet glass 1 forming the bent portion 33, and a second space portion S2 is formed laterally between a second virtual line L2 (which coincides with the vertical surface 62a of the die 60 in FIG. 7) perpendicular to the first virtual line L1 and passing through an inner backside end of the skirt portion 32 and the back surface of the sheet glass 1 forming the bent portion 33. This is caused by that the sheet glass 1 does not completely fit along the die 60 due to rigidity of the sheet glass 1 itself even when the viscosity of the sheet glass 1 is increased. Incidentally, the back surface of the sheet glass 1 forming the display portion 31 and the back surface of the sheet glass 1 forming the bent portion 33 mean respective regions each of which is composed of a large portion thereof, not a local portion thereof. Further, in some cases, the second space portion S2 takes the maximum distance between the second virtual line L2 and the back surface of the sheet glass 1 forming the skirt portion 32.

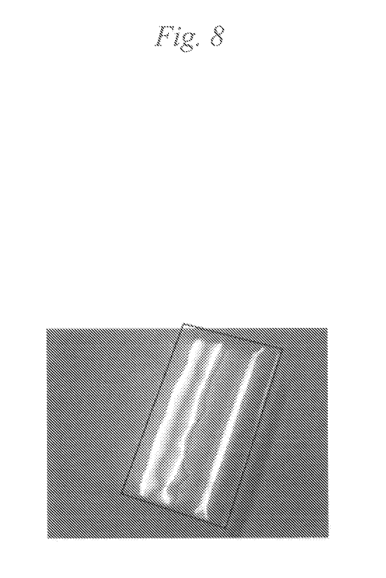

In FIG. 7, the maximum distance T1 in a front-back direction of this first space portion S1 (hereinafter referred to as the maximum distance T1) indicated 0.234 mm, and the maximum distance T2 in a width direction of the second space portion S2 (hereinafter referred to as the maximum distance T2) indicated 1.371 mm. Further, when the cover glass 30 actually subjected to bending as in the case of this simulation was irradiated with three fluorescent lamps, there was observed the occurrence of waviness in reflected light by an influence of optical strain, as shown in FIG. 8.

Further, item (b) in FIG. 6 shows, as a comparative example, simulation results at the time when the in-furnace temperature is set so that the region 1a to be the display portion 31 is uniformly heated to 600° C. (viscosity: 1.13 Pa·s) and whole of the region 1c to be the skirt portion 32 is uniformly heated with the electric heater 67 so that the maximum viscosity point thereof becomes 700° C. (viscosity: 0.765 Pa·s), thereby performing bending formation of the sheet glass 1 in which the distance in the width direction between the maximum viscosity point and the low viscosity adjacent point is set to 20 mm. Incidentally, the region 1b to be the bent portion 33 has a temperature gradient due to an influence of heating with the electric heater 67. At this time, the maximum distance T1 indicated 0.1511 mm, and the maximum distance T2 indicated 0.7341 mm.

Item (c) in FIG. 6 shows, as an example of the invention, simulation results at the time when the in-furnace temperature is set so that the regions 1a and 1c to be the display portion 31 and the skirt portion 32 are uniformly heated to 600° C. (viscosity: 1.13 Pa·s) and the region 1b to the bent portion 33 is heated with the electric heater 67 so that the maximum viscosity point becomes 700° C. (viscosity: 0.765 Pa·s), thereby performing bending formation of the sheet glass 1 in which the distance in the width direction between the maximum viscosity point and the low viscosity adjacent point is set to 20 mm. At this time, the maximum distance T1 indicated 0.1094 mm, and the maximum distance T2 indicated 1.0618 mm.

As the cover glass 30, the maximum distance T1 is preferably 0.14 mm or less. An influence on the appearance of the bent portion 33 can be reduced by adjusting the maximum distance T1 to 0.14 mm or less, and the occurrence of optical strain can be inhibited by adjusting the viscosity of the region la to be the display portion 31 to 10¹¹ Pa·s or more. T1 is more preferably 0.11 mm or less, and particularly preferably 0.07 mm or less. Further, the maximum distance T2 is preferably 0.5 mm or less. An influence on the appearance of the bent portion 33 and the skirt portion 32 can be reduced by adjusting the maximum distance T2 to 0.5 mm or less. Accordingly, in the methods shown in items (a) and (b) in FIG. 6, the maximum distance T1 increases to more than 0.14 mm to exert an adverse influence on the appearance of the bent portion 33. In contrast, in the method shown in item (c) in FIG. 6, the maximum distance T1 becomes 0.14 mm or less, and the maximum distance T2 becomes 0.5 mm or less, which satisfies the requirements as the cover glass 30.

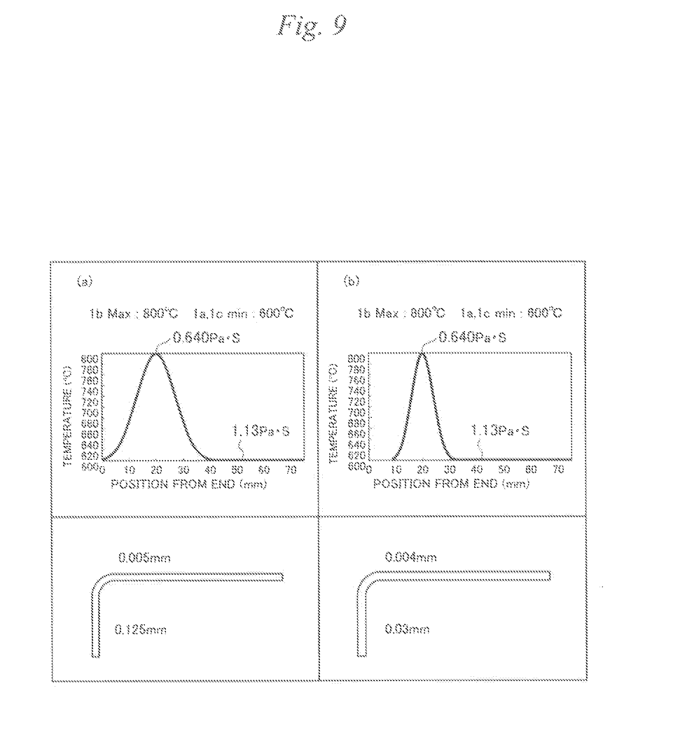

FIG. 9 shows heating conditions different from the local heating of item (c) in FIG. 6 and graphs showing simulation results obtained thereby. In item (a) in FIG. 9, the local heating is performed to a higher temperature than in item (c) in FIG. 6, and in item (b) in FIG. 9, the local heating is performed to a higher temperature and at a steeper temperature gradient than in item (c) in FIG. 6.

Item (a) in FIG. 9 shows simulation results at the time when the in-furnace temperature is set so that the regions 1a and 1c to be the display portion 31 and the skirt portion 32 are uniformly heated to 600° C. (viscosity: 1.13 Pa·s) and the region 1b to be the bent portion 33 is uniformly heated with the electric heater 67 so that the maximum viscosity point thereof becomes 800° C. (viscosity: 0.640 Pa·s), thereby performing bending formation of the sheet glass 1 in which the distance in the width direction between the maximum viscosity point and the low viscosity adjacent point is set to 20 mm. At this time, the maximum distance T1 indicated 0.005 mm, and the maximum distance T2 indicated 0.125 mm. Compared to item (c) in FIG. 6, both the maximum distances T1 and T2 can be decreased.

Further, item (b) in FIG. 9 shows simulation results at the time when the in-furnace temperature is set so that the regions 1a and 1c to be the display portion 31 and the skirt portion 32 are uniformly heated to 600° C. (viscosity: 1.13 Pa·s) and the region 1b to be the bent portion 33 is uniformly heated with the electric heater 67 so that the maximum viscosity point thereof becomes 800° C. (viscosity: 0.640 Pa·s), thereby performing bending formation of the sheet glass 1 in which the distance in the width direction between the maximum viscosity point and the low viscosity adjacent point is set to 10 mm. At this time, the maximum distance T1 indicated 0.004 mm, and the maximum distance T2 indicated 0.03 mm. Compared to item (c) in FIG. 6, both the maximum distances T1 and T2 can be decreased.

For example, the above-mentioned simulation of item (c) in FIG. 6 is realized by disposing an electric heater (manufactured by Sakaguchi E.H Voc Corporation, Rayrod Super, 6 mm in diameter) 5 mm directly above the bent portion 33 in an electric furnace (in an atmospheric atmosphere) actually heated at 600° C., setting the set temperature thereof to 820° C., keeping that state for 5 minutes, and thereafter gradually cooling to room temperature taking 5 hours.

As described above, according to the cover glass 30 of this embodiment, the skirt portions 32 extending backward to the display portion 31 are formed on the both sides in the width direction of the display portion 31, whereby the design is more improved and a higher-class feeling can be imparted to the cover glass 30 utilizing a texture of glass. Further, the edges of the cover glass 30 are provided in the skirt portions 32 and face backward, so that a chamfering treatment can be simplified, compared to the case where the edges are exposed forward. Furthermore, there can be reduced a possibility that chipping of the edges occurs.

Further, the skirt portions 32 are formed by bending one straight sheet glass 1 at the bent portions 33. In the cross section in the thickness direction, the first space portion S1 is formed forward between the first virtual line L1 extending the back surface of the sheet glass 1 forming the display portion 31 in the width direction and the back surface of the sheet glass 1 forming the bent portion 33, and the maximum distance T1 in the front-back direction of the first space portion S1 is 0.14 mm or less. The second space portion S2 is formed laterally between the second virtual line L2 perpendicular to the first virtual line L1 and passing through the inner backside edge of the skirt portion 32 and the back surface of the sheet glass 1 forming at least one of the bent portion 33 and the skirt portion 32, and the maximum distance in the width direction of the second space portion S2 is 0.5 mm or less. Accordingly, deterioration of the design of the cover glass 30 can be prevented.

Furthermore, according to the production method of the cover glass 30 of this embodiment, the cover glass 30 which is good in design and has a higher-class feeling utilizing a texture of glass can be produced by locally heating the regions 1b be to the bent portions 33 of the sheet glass 1. Further, the edges of the cover glass 30 are provided in the skirt portions 32 and face backward, so that the chamfering treatment can be simplified, compared to the case where the edges are exposed forward. Furthermore, there can be reduced a possibility that chipping of the edges occurs.

In addition, in the heating step (S2), heating is performed so that the viscosity of the regions 1a and 1c to be the display portion 31 and the skirt portions 32 of the sheet glass 1 or the whole portions 1a to 1c of the sheet glass 1 becomes 10¹¹ to 10¹⁵ Pa·s, and in the local heating step (S3), the local heating is performed so that the maximum viscosity of the regions 1b to be the bent portions 33 becomes 10⁷ to 10⁹ Pa·s and so that the distance in the width direction between the maximum viscosity point having the maximum viscosity of the regions 1 b to be the bent portions 33 and the low viscosity adjacent point closest to the maximum viscosity point in the width direction, in regions in which the viscosity becomes 10¹¹ to 10¹⁵ Pa·s, becomes 30 mm or less, thereby being able to produce the cover glass 30 which is excellent in design, while inhibiting the influence of the display portion on visibility and inhibiting cracks of the glass.

Further, in the local heating step, the sheet glass 1 is formed by bending it at the regions 1b to be the bent portions 33 under its own weight, or formed by pressing the regions 1b to be the skirt portions 32 to the vertical surface 62a of the die 60, thereby being able to improve productivity of the cover glass 30.

Furthermore, in the local heating step, the sheet glass 1 can be locally heated to the desired viscosity by heating the regions 1b to be the bent portions 33 with the electric heaters 67 in a noncontact state in the furnace.

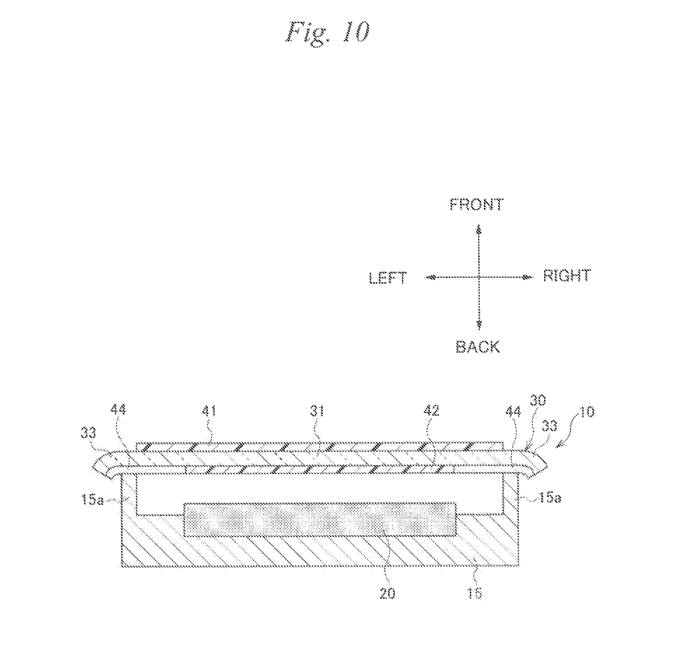

Incidentally, in the above-mentioned embodiment, there has been exemplified the cover glass 30 including the display portion 31 planarly extending and being positioned in front of the display panel 20, the bent portions 33 bent from the display portion 31 on the both sides in a horizontal direction (width direction) of the display portion 31 and the skirt portions 32 extending backward from the bent portions 33. However, without being limited thereto, the cover glass may includes a display portion 31 planarly extending and being positioned in front of a display panel 20 and bent portions 33 bent from the display portion 31 on both sides in a horizontal direction (width direction) of the display portion 31, as shown in FIG. 10. Also by this cover glass, the bent portions 33 are formed on the both sides in the width direction of the display portion 31, whereby the design is more improved and a higher-class feeling can be imparted to the cover glass utilizing a texture of glass. Further, the edges of the cover glass 30 are provided in the bent portions 33 and face backward, so that the chamfering treatment can be simplified, compared to the case where the edges are exposed forward. Furthermore, there can be reduced a possibility that chipping of the edges occurs.

The production method of this cover glass is provided with a skirt portion removing step of cutting the cover glass at the bent portions 33 or between the bent portions 33 and the skirt portions 32 to remove the skirt portions 32, between the bending step (S4) and the chemical strengthening step (S5), in the flow chart of the method for producing a cover glass for flat panel displays shown in FIG. 3.

Side walls 15a of a housing 15 may be positioned inside the bent portions 33 or formed so as to cover the bent portions 33 from the outside. By forming the side walls so as to cover the bent portions 33 from the outside, the chamfering step can be performed more easily than ever before, and can also be omitted.

The present application is based on Japanese Patent Application No. 2010-251584 filed on Nov. 10, 2010, and the contents are incorporated herein by reference.

### DESCRIPTION OF REFERENCE NUMERALS AND SIGNS

1: Sheet glass

1a: Region to be a display portion

1b: Region to be a bent portion

1c: Region to be a skirt portion

20: Display panel (image display portion)

30: Cover glass (cover glass for flat panel displays)

31: Display portion

32: Skirt portion

33: Bent portion

60: Die

62a: Vertical surface

63a: Horizontal surface

63b: Arc surface

67: Electric heater (heating member)

L1: First virtual line

L2: Second virtual line

S1: First space portion

S2: Second space portion

What is claimed is:

1. A cover glass for flat panel displays, which is formed of a sheet glass, the cover glass comprising:
a display portion planarly extending and being positioned in front of an image display portion; and
bent portions bent from the display portion on both sides in a width direction of the display portion.

2. The cover glass for flat panel displays according to claim 1,
wherein, in a cross section in a thickness direction of the cover glass, a first space portion is formed forward between a first virtual line extending a back surface of the sheet glass forming the display portion in the width direction and a back surface of the sheet glass forming the bent portion, and
a maximum distance in a front-back direction of the first space portion is 0.14 mm or less.

3. The cover glass for flat panel displays according to claim 1, wherein the cover glass has skirt portions extending backward from the bent portions.

4. The cover glass for flat panel displays according to claim 3, wherein the skirt portions are formed by bending the sheet glass at the bent portions.

5. The cover glass for flat panel displays according to claim 4,
wherein a second space portion is formed laterally between a second virtual line perpendicular to the first virtual line and passing through an inner backside edge of the skirt portion and the back surface of the sheet glass forming at least one of the bent portion and the skirt portion, and
a maximum distance in a width direction of the second space portion is 0.5 mm or less.

6. A method for producing a cover glass for flat panel displays, which is formed of a sheet glass and comprises a display portion planarly extending and being positioned in front of an image display portion, bent portions bent from the display portion on both sides in a width direction of the display portion and skirt portions extending backward from the bent portions, the method comprising:
a chemical strengthening step; and
a sheet glass processing step of preparing a sheet glass to be subjected to the chemical strengthening step,
wherein the sheet glass processing step comprises:
a heating step of heating regions to be the display portion and the skirt portions in the sheet glass or the whole sheet glass to have a predetermined viscosity;
a local heating step of locally heating regions to be the bent portions in the sheet glass; and
a bending step of forming the skirt portions by bending the sheet glass at the regions to be the bent portions, during or after the local heating step.

7. The method for producing a cover glass for flat panel displays according to claim 6,
wherein, in the heating step, heating is performed so that the viscosity of the regions to be the display portion and the skirt portions in the sheet glass or the whole sheet glass becomes 10¹¹ to 10¹⁵ Pa·s, and
in the local heating step, local heating is performed so that a maximum viscosity of the regions to be the bent portions becomes 10⁷ to 10⁹ Pa·s and so that a distance in a width direction between a maximum viscosity point showing the maximum viscosity of the regions to be the bent portions and a low viscosity adjacent point closest to the maximum viscosity point in a width direction, in regions in which the viscosity becomes 10¹¹ to 10¹⁵ Pa·s, becomes 30 mm or less.

8. The method for producing a cover glass for flat panel displays according to claim 6, wherein, in at least the local heating step and the bending step, the sheet glass is bent at the regions to be the bent portions under its own weight by:
using a die having at least vertical surfaces extending in a direction of gravitational force, a horizontal surface extending in a direction perpendicular to the direction of gravitational force and arc surfaces having a predetermined curvature connecting the horizontal surface and each of the vertical surfaces;
arranging the region to be the display portion on the horizontal surface, arranging the regions to be the bent portions so as to face the arc surfaces, and arranging the regions to be the skirt portions so as to protrude from the vertical surfaces; and
locally heating the sheet glass.

9. The method for producing a cover glass for flat panel displays according to claim 6, wherein, in the local heating step and the bending step, the sheet glass is bent at the regions to be the bent portions under its own weight by:
using a die having at least vertical surfaces extending in a direction of gravitational force, a horizontal surface extending in a direction perpendicular to the direction of gravitational force and arc surfaces having a predetermined curvature connecting the horizontal surface and each of the vertical surfaces;
arranging the region to be the display portion on the horizontal surface, arranging the regions to be the bent portions so as to face the arc surfaces, and arranging the regions to be the skirt portions so as to protrude from the vertical surfaces; and
locally heating the sheet glass, and pressing the regions to be the skirt portions to the vertical surfaces.

10. The method for producing a cover glass for flat panel displays according to claim 6, wherein, in the local heating step, the regions to be the bent portions are heated with a heating member in a noncontact state in the furnace.

11. A method for producing a cover glass for flat panel displays, which is formed of a sheet glass and comprises a display portion planarly extending and being positioned in front of an image display portion and bent portions bent from the display portion on both sides in a width direction of the display portion, the method comprising:
a chemical strengthening step; and
a sheet glass processing step of preparing a sheet glass to be subjected to the chemical strengthening step,
wherein the sheet glass processing step comprises:
a heating step of heating region to be the display portion and regions to be skirt portions positioned on the opposite side of the display portion with respect to the bent portions in the sheet glass or the whole sheet glass to have a predetermined viscosity;
a local heating step of locally heating regions to be the bent portions in the sheet glass;
a bending step of forming the skirt portions by bending the sheet glass at the regions to be the bent portions, during or after the local heating step; and
a skirt portion removing step of cutting the cover glass at the bent portions or between the bent portions and the skirt portions to remove the skirt portions.
